(19) United States
(12) Patent Application Publication
(10) Pub. No.: US 2021/0386010 A1
(43) Pub. Date: Dec. 16, 2021

(54) TANGENTIAL INLET DEVICE FOR SOLIDS DISTRIBUTION TRAILER

(71) Applicant: METALFOR S.A., Marcos Juarez (AR)

(72) Inventor: Gustavo WALKER, Caba (AR)

(21) Appl. No.: 17/345,519

(22) Filed: Jun. 11, 2021

(30) Foreign Application Priority Data
Jun. 16, 2020 (AR) P20200101696

(51) Int. Cl. A01C 17/00; B05B 3/10

(52) U.S. Cl. CPC A01C 17/001; E01H 10/007; B05B 3/1007

(57) ABSTRACT

A device to distribute solids such as seeds, fertilizers, salts, or other granular materials through a machine for agricultural use or other similar uses, of the type that uses horizontal rotating plates or discs with spreader pallets, wherein access of the material to be distributed to the spreader pallets is tangential thereto, by use of a channeller downloaded in the central area of the disc. The device does not break the particles to be spread and, thereby, they maintain their original mass, which let us affirm that the working area is extended and the uniformity of the distribution is improved. Additionally, the tangential access of the material from the center of the rotating plate or disc, and with the same course of the pallets, gives an additional speed to the particles that allows to further increase the working area.

### CROSS-REFERENCE TO RELATED APPLICATION

This application claims the benefit of priority of Argentinian Patent Application No. P20200101696, filed on Jun. 16, 2020, which is incorporated herein by reference.

### FIELD OF THE INVENTION

Machine for agricultural use or other similar uses requiring the distribution of granular material, such as fertilizers, seeds, salts, etc., and that use rotating discs or plates, that have spreader pallets and that can be assembled on the front or rear part of the unit.

### PRIOR ART AND PROBLEMS TO BE SOLVED

The invention refers to the manner in which the material to be distributed accesses from the hopper that contains it, to the spreader pallets of the granular products that are arranged in one or two rotating horizontal plates or discs that are usually assembled on the front or rear part of the machine, always under the container or hopper that contains it. For example, in the case of broadcast sowing, fertilizing or spreading agricultural machines, belonging to the current state of the art, the material to be distributed, such as seeds or fertilizers, is released vertically over the spreader discs, which have one or more pallets that propel the material at a certain distance from the machine and, obviously, the broader the scope reached, the wider the working area and the operation will be more efficient. The salt spreader machines work in a similar manner to melt ice over roads, designed based on fertilizing agricultural machines, but in general with one or two spreader discs assembled on the front part of the vehicle.

One of the problems of these distribution systems is the manner in which the material accesses to the pallets, since the quality of the distribution is directly related to this characteristic.

Following with the example of the application of agricultural products, the main aspects to be considered by the producer are achieving a homogeneous distribution of the material on the floor, the broader scope possible to reduce fuel costs and maintaining the material to be distributed without breaking, whether they be seeds or fertilizers given the germination power of the seeds and the scope for both products will be reduced inasmuch as they are damaged, since as the mass is reduced, the same happens with the distance reached by the material, besides affecting the distribution on the floor, which ultimately economically affects the agricultural producer.

Depending on the physical characteristics of the material to be distributed, on the geometry concerning the discs and their pallets, on the assembly type they have and mainly on the rotation speed, the scope may be broader or reduced. For example, in the case of fertilizers, it has been proven that in the case of urea, one of most used fertilizers, at a same rotation speed of the discs, the granules of 4.7 mm of diameter achieve a dispersion distance of 20 mt, while those of 1.7 mm only achieve 10 mt.

That said, when the material falls in a disordered transition over the discs that rotate approximately at 700 rpm, and that further have one or more spreader pallets, it will typically break due to the impact produced when it bumps into the discs, and thereby, ceases to be uniform. Furthermore, a high turbulence in the impact zone is also produced, which is another factor that affects the distribution, precisely because of the rebound produced between the same particles that collide into each other o into the broken parts, etc.

For example, in the case of urea, the particle is covered with acidifying additives or with Sulphur, so as to minimize the volatilization, because if it is hot, up to 80% of its volume can be lost and, thereby, its fertilization ability. But if the particle is broken, the protection is lost and the ammonia is volatilized, affecting not only the fertilization ability but also the quality of distribution due to the mass loss.

That is to say, that the breakage of the material to be spread reduced the scope and thereby the working area, the homogeneity in the distribution, reduces germination ability in the case of seeds and fertilization ability in the case of fertilizers, economically affecting the producer. However, this is a problem that has not always been considered by manufacturers of these type of machines.

In the current state of the art in the field of spreader machines of solid materials, there are many solutions aimed at improving the homogeneity of the distribution and achieving a broader scope, or modifying the volume of the material controlling the supply to each disc independently in order to achieve a more precise dosage, according to the position of the machine or of eventual interferences such as trees, but there are virtually no solutions specifically raised to prevent the breakage of the material to be distributed at the moment of accessing to the spreader pallets.

There may be some solutions that in any manner aim at alleviating the problem, even partially, and without being the main object of the invention. For example, the American patent “US6209808B1 Spreader attachment” discloses a funnel-shaped structure assembled just above each of the rotating discs or plates, that internally includes deflector spans allowing the choice of the access or dropping point of the material over the disc, either towards the center or the periphery. In fact, this solution is posed to improve the distribution of the organic material, but, as it can direct the unloading towards center of the disc, wherein the tangential speed is lesser than the one on the periphery, it can be estimated that the bump suffered by the material is lesser than if the deflector span directs the drop to the periphery of the disc. Anyway, the material will always fall vertically over the plane defined by the disc and, obviously, the impact will likewise affect it.

Another solution, similar to the above mentioned one, is the one disclosed in the European publication EP1955579A1 Machine et procedé d'epandage centrifuge d'engrais ou de produits similaires en grains that includes a director of the flow of the material to be downloaded to modify the access or dropping point, but it is always vertical.

Another alternative solution is disclosed in publication “WO2019/109189A1 Spreader for particulate material with improved”, in which four small gates are used over each disc, that ultimately allow that the download of the material is produced towards the center of the disc or to the periphery. But the fall of the seed is virtually perpendicular to the plane of the disc, and the impact affects them as in the above-mentioned documents.

That is to say that there is a need for a system that prevents that the material to be distributed is broken when falling over the rotating discs either due to the impact against it or, worst, against the propeller pallets, since it not only breaks the product and affects the quality of the material to be used, but it also changes the distribution as the particle is fired in any direction. At the same time, the scope and obviously the working area is also reduced as it has a lesser mass, and therefore it falls closer to the machine. This situation is given in any type of solid spreader machines, as the purpose is always to achieve a homogeneous distribution and with the greater working scope possible, whether it is seeds, fertilizers or any other granular material.

It is therefore a purpose of the present invention to achieve a system that does not damage the material during the access to the spreader pallets.

Another purpose of the present invention is not to prejudice the distribution or scope of the distributed material.

Another purpose of the invention is to contribute to achieve a broader scope and uniformity of the distribution for discs rotating at the same speed than the discs of machines already known in the current state of the art.

It is another purpose of the present invention to reduce the turbulence generated when the material falls over the disc.

It is still another purpose of the invention that the access or dropping point of the material over the disc is as close as possible to the center thereof.

It is still another purpose of the invention that the device can rotate the access or dropping point of the material over the rotating plate or disc, always as close as possible to the center thereof, either in manual mode, automatically or through a hybrid of both.

And it is still another purpose of this invention that the fall of the material over the rotating disc or plate takes place from a very low height.

And it is still another purpose of the invention that the distance between the spreader pallets and the dropping point of the material be as minimal as possible.

And it is still another purpose of the invention that, adjusting dimensions, it can replace the rotating spreader devices of machines of other national or international manufacturers.

### BRIEF DESCRIPTION OF THE INVENTION

The present invention seeks to prevent the breakage of the granulated materials in general, such as seeds fertilizers, salts, etc, that are distributed with machines that have one or two rotating discs or plates, that at the same time have one or more spreader pallets, at the moment of accessing to the pallets to avoid the above mentioned problems.

Basically, the invention is based on the fact that the material to be distributed is placed on the rotating discs or plates, through a channeller that, even though it can have different forms, such as a straight, spoon or curve, in all cases allows that the access or dropping point of the material be practically in the center of the plate or disc and closer to the surface, there being a millimetric distance between said access or dropping point and the spreader pallets, which avoids turbulence. This way of delivering the material to the disc is much softer than in the systems already known in the current state of the art, as it is carried out tangentially to the plane defined by the disc and does not have to change its direction, as it coincides with the direction of the pallets, while in the current systems, it is carried out vertically. All this contributes so that the particle does not break and therefore maintains its original mass, the scope of the work foreseen and the uniformity in the distribution.

Furthermore, as the fertilizers have spherical shape and can flow very well, when entering practically from the center of the disc following the same route of the pallet to the periphery and with a speed plus given by the channeller shape, an increase in the scope of the distribution can be achieved, extending the working area of the machine. That is to say that for a same rotation speed of the plate, the object of the present invention allows an increase in the width of the work due to the additional plus of speed obtained when the download is carried out through the channeller. The distribution is also improved because with the object of the present invention, the material is already deposited on the plane of the disc when the spreader pallet propels it, and it will therefore be directed as planned.

Another advantage of the tangential entering of the material to be distributed is that it significantly reduces the turbulence for the simple fact that the particles do not bump each other, they all flow from the center, where the access or dropping point is located, and the disc has a lower tangential speed, moving towards the periphery of the plate with additional speed.

Furthermore, the mentioned channeller can rotate in one direction or the other, since the outlet is always maintained at the same distance to the center of the plate, some few millimeters. This allows modifying the access or dropping point of the material over the plate or disc according to the type of material and its specification, such as, for example, its granulation and specific weight, which results in that the distribution manner of the product can be modified. Additionally, the rotation of the channeller can be made manually before starting the work, but also automatically and without stopping the motion of the unit, because it can be commanded through an electric engine that acts jointly with a global positioning system (GPS) that offers information instantly, including through a hybrid of both systems.

### BRIEF DESCRIPTION OF THE DRAWINGS

FIG. 1 shows a fertilizer or spreader machine of the type of gravity drop and belonging to the current state of the art.

FIG. 2 is a photograph of the machine of FIG. 1, belonging to the current state of the art, working in the field and submitted for illustrative purposes only.

FIGS. 3a, 3b and 3c are photographs of plates or discs belonging to the current state of the art and submitted for clarification purposes.

FIG. 4 is a view of the object of the invention.

FIG. 5 is a plan view of the object of the invention.

FIG. 6 is a view of the object of the invention to which some components have been withdrawn.

FIG. 7 is a view of the object of the invention with another channeller shape.

FIG. 8 is a scheme that represents the movement of the particles in the object of the present invention when entering the plate and spreader pallets.

FIGS. 9a and 9b are two real photographs of the prototype of the object of the present invention assembled on a fertilizer machine and submitted for clarification purposes only.

FIGS. 10a and 10b are schemes that represent the channeller rotated on its vertical axis.

### DETAILED DESCRIPTION OF THE INVENTION

The present invention refers to the manner in which the solid material to be distributed accesses to the spreader pallets arranged on the rotating discs or plates of a machine for agricultural use or other similar uses to prevent that it breaks due to the impact produced when it bumps into its own disc and mainly, into the propeller pallets.

Even though the main field of interest of the invention are the disc seeders and fertilizer agricultural machines, the invention can also be applicable for the distribution of solid materials in other types of applications, such as for example for machines that distribute salts in routes to melt ice, as the problems to be solved are similar.

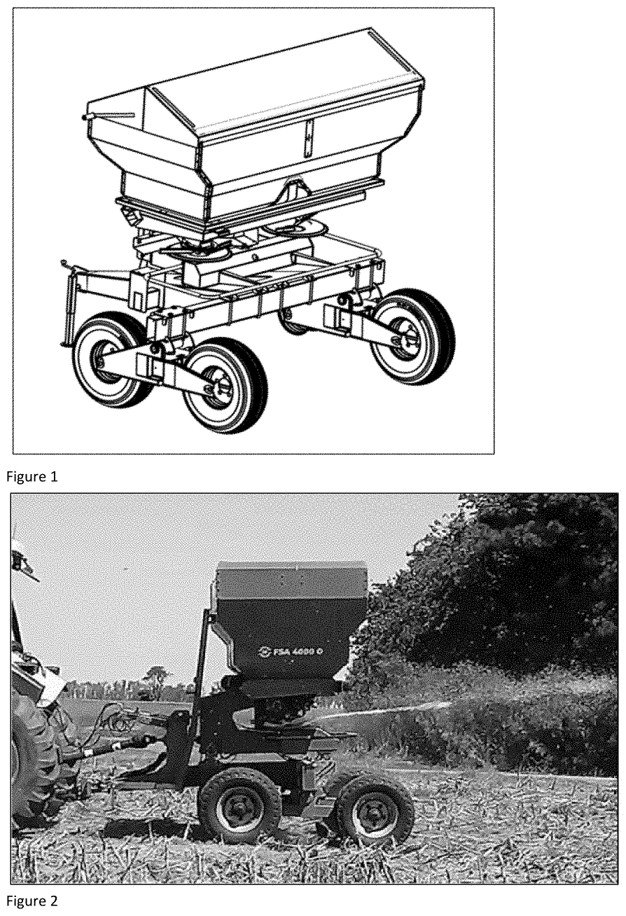

FIG. 1 shows a fertilizer or spreader agricultural machine of the type of gravity drop, as the hopper (1) with the material to be distributed is directly over the rotating discs or plates (2). This type of machines is dragged by a tractor but there are bigger ones that are self-propelled, that include conveyor belts inside them, scales, etc., but the material to be distributed always drops virtually in vertical manner over the discs, so that the object of the invention is perfectly applicable to any of these machines.

FIG. 2 is a photograph of the machine mentioned in the above figure, working in the field, and submitted for illustrative purposes only.

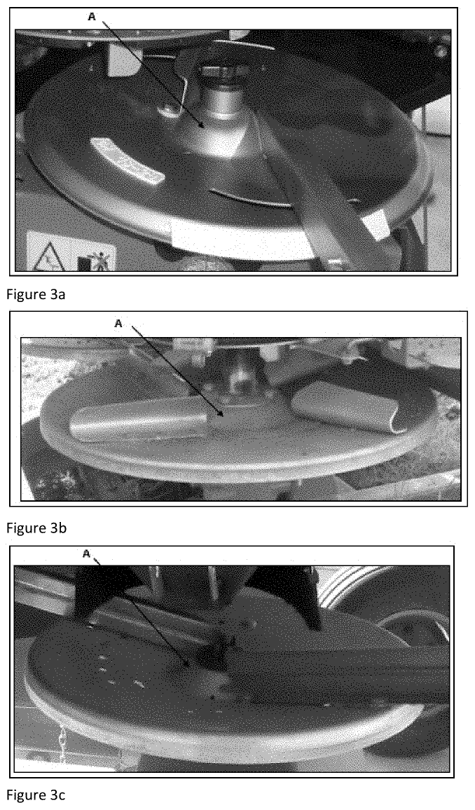

FIGS. 3a, 3b and 3c are photographs of the rotating plates or discs belonging to the current state of the art, and submitted for clarification purposes, as it is intended to show that in general they have in the center a convex part (A) that in fact makes that the dropping point of the material moves away from the center of the plate and, thereby, that it is bumped by the pallets at a higher tangential speed, as it increases as one moves away from the center of the disc. As a result of this, breakage and turbulence of the particles increases, that is what the object of this invention tries to avoid and that will be explained below.

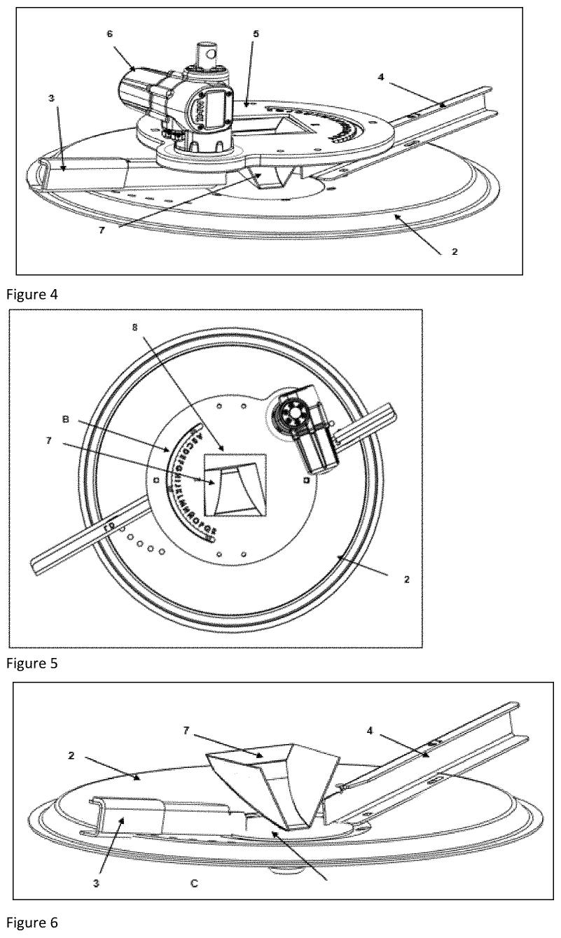

FIG. 4, is a view of the object of the invention, formed by a rotating plate or disc (2) wherein the spreader pallets (3) and (4) and a support (5) assembled on the plate or disc (2) can be observed, and that includes an electric engine (6) and the channeller (7), through which the material enters from the hopper. It can be noted that it has a curved shape, so that the material does not enter vertically to the disc, but following the shape of the channeller. Likewise, the electric engine (6) shall be in charge of rotating, in the horizontal plane, the position of the channeller (7) in one direction or the other, and this way varying the position of the access or dropping point of the material to be distributed, but always around the center of the plate or disc (2), in the case of implementation of an automatic control.

FIG. 5 is a plan view of the object of the invention, wherein it can be observed that the channeller (7) is centered with the axis of the plate or disc (2), entering the material to be distributed through the window (8). A slide B with a set of letters from A to R engraved over the support (5) can also be observed, which allows the manual adjustment to rotate in the horizontal plane the position of the channeller (7) in one direction or the other, and this way vary the position of the access or dropping point of the material to be distributed, but always around the center of the plate or disc (2). For example, in the case of this figure, the position is show with letter J.

FIG. 6 is a new view of the object of the invention, similar to FIG. 4, but in this case some components have been withdrawn to better appreciate the shape of the channeller (7), which is fundamental for the invention, and that allows that the material enters tangentially to the plate or disc (2) and to the propeller pallets (3) and (4). It is also important to highlight that the download of the channeller (7) takes place practically in the center of the plate or disc (2) and in a flat area (C) thereof, of 20 to 150 mm of diameter, for plates or discs of the “concave” type, such as the one shown in this figure. This characteristic is an important advantage as regards the typical discs viewed in FIGS. 3a, 3b and 3c, as explained in FIG. 8 below. Additionally, it can be observed that the shape of the channeller is curved, even if it can be any shape, the important point is that it allows that the access of the material to the disc (2) and spreader pallets (3) and (4) takes place softer than in the machines belonging to the current state of the art.

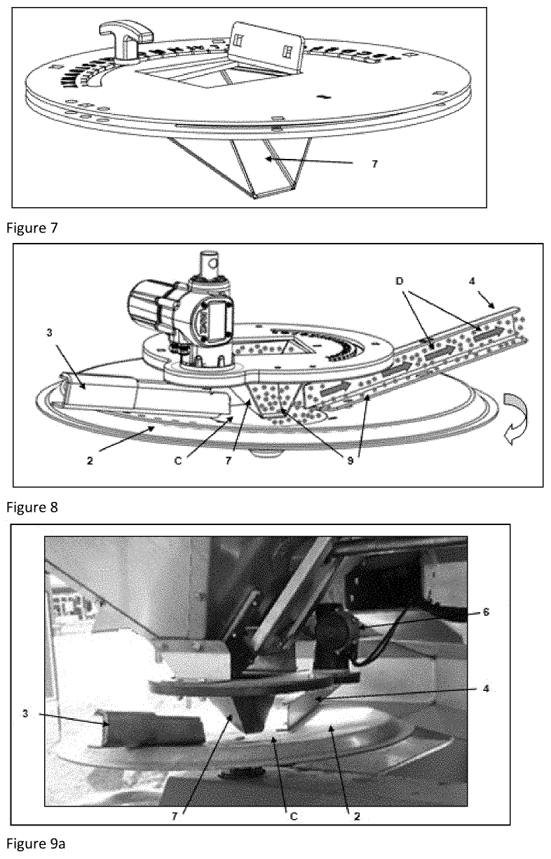

FIG. 7 is an example of what has been mentioned in above figure. In this case, the channeller (7) is straight and not curved, but the function is the same as mentioned above.

FIG. 8 is a scheme that allows viewing, even out-of-scale since the spherical particles (9) of the fertilizer are much more smaller than the ones shown in the figure, how they behave when tangentially entering the disc (2) and, therefore, to the pallets (3) and (4), which results fundamental to understand the importance of the object of the invention to solve the problems posed. To start with, the spheres (9) do not fall vertically over the disc (2), but through the channeller (7) that, as already mentioned, “delivers” them in a softer manner that in the known systems, in a flat area (C) of the center of the disc, where the tangential speed thereof is practically zero and further with a certain radial speed that is precisely generated by the own shape of the channeller (7).

Furthermore, the height from which the particles fall from the channeller to the plate or disc (2) is reduced, included within 1 and 30 mm and therefore no rebounds against the rotating disc or plate (2) take place. Additionally, it is important to highlight that the distance between the channeller and the pallets is also reduced, included within a range of 1 to 15 mm, which allows that the spherical particles (9) access immediately and tangentially to the pallet (4), flowing without resistance as stated by the arrows (D), and following the direction of the pallet (4), and further with the additional “plus” of speed that is generated by the shape of the channeller (7), which eases that the material can reach a greater distance for the same rotation speed of the disc.

Additionally, as the particles (9) enter to the pallets (3) and (4) in a point wherein the speed is practically zero, they do not receive a bump as it happens in the machines included in the current state of the art, and therefore they will not break as they do not bump to the extent they do in the current machines. The figure also eases understanding that with the use of the channeller (7), the spreader pallets (3) and (4) have a better control over the distribution, as they “do no bump in the air”.

Everything explained herein makes it possible to understand that the object of the invention prevents the generation of turbulence as there are no rebounds and the particles enter directly to the pallets that are a few millimeters away from the access or dropping point of the material, with the same direction thereof.

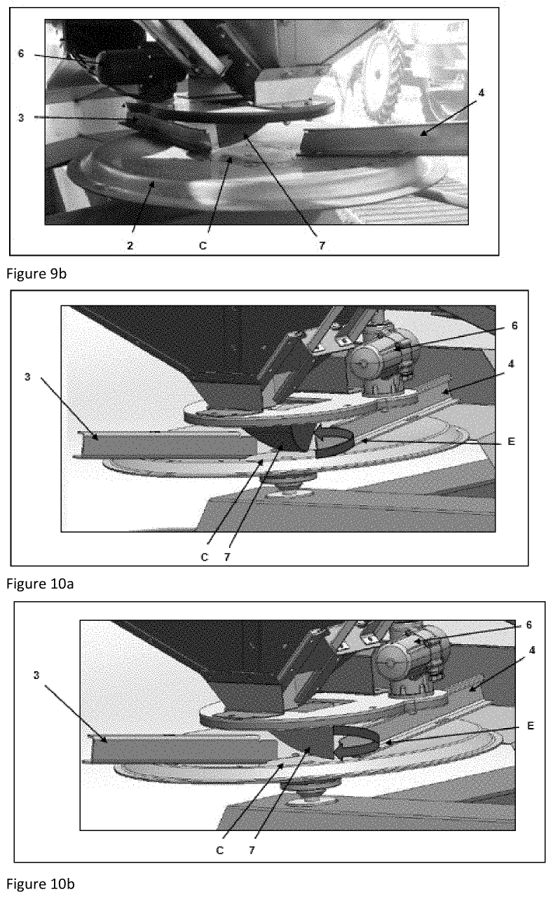

FIGS. 9a and 9b are two real photographs taken from different positions of the object of the invention already assembled in a machine and submitted for clarification purposes of the following two figures. In both photographs the plate or disc (2), the spreader pallets (3) and (4), the channeller (7) and the electric engine (6) can be observed. It can also be observed that together with the following two figures, they allow viewing the channeller (7) rotating over its vertical axis to modify the access or dropping point of the particles, but always within the flat area (C) and very close to the center of the plate or disc (2).

FIGS. 10a and 10b represent the object of the invention assembled on a machine, wherein it can be observed that the channeller (7) is rotated in two different angular positions regarding the spreader pallets (3) and (4). Said rotation is carried out manually or through the engine (6) as explained in FIGS. 4 and 5. For example, in FIG. 10a, the red arrow (E) states that it rotates in anticlockwise direction while in FIG. 10b it rotates clockwise. That is to say, the access or dropping point of the material to be distributed is always within the flat area (C) of the center of the plate, but being able to rotate the channeller (7) in one direction or the other, allows better monitoring of the manner of distribution of the product as the pallets usually have a different length to achieve a broader or reduced projection of the particles.

In brief, and according to what has been explained through the different figures, it can be understood that the object of the invention introduces important improvements in comparison with the devises included in the current state of the art regarding the distribution of solids, either seeds, fertilizers, salts or any other granular material, since the possibility of breakage of the particles of the products is reduced as the material tangentially enters the spreader pallets, achieving a broader scope and working area for a disc of equal size and rotation speed, virtually eliminates turbulences and offers a better control over the manner and uniformity of the distribution, resulting in an increase of the application efficiency and an economical benefit for the user.

Additionally, it is worth mentioning that all herein explained for concave plates or discs and with two spreader pallets is also perfectly applicable for completely flat plates or discs, and for discs with one, two or more spreader pallets, since it depends on the material to be distributed and on the application, but the functionality to be protected is always the same.

At the same time, the application of the principles of the invention and a first preferred embodiment thereof have been disclosed and described in detail in this document, but it is herein stated that it is possible to implement other alternative embodiments without departing from said principles, for instance, using one channeller with any other form apart from the already mentioned ones, but that eases the tangential access of the particles to the spreader pallets.

Finally, considering that in the Argentine market there exist around 100 different models of centrifugal fertilizers, most of them with double disc, and that they have a participation of the range of 70% of the total market of fertilizers, the object of the present invention may be arranged with different disc sizes to be commercialized as a kit, in order to replace the spreader discs of any existing machine in the local, and inclusive international, market.

1. A tangential inlet device for solids distribution trailer, of the type used in a machine for agricultural use that distribute granular material comprising:
one or more rotating plates or discs configured to spread the granular material homogeneously;
at least one spreader pallet;
a support that has an opening in its center through which the granular material enters to a channeller, that can be rotated through a manual and/or electrical actuating mechanism, and wherein an outlet is placed over a flat area, located in a center of the one or more rotating plate or disc assembled under the channeller.

2. The tangential inlet device for solids distribution trailer according to claim 1, wherein a distance between the outlet of the channeller and the spreader pallets is between 1 and 15 mm.

3. The tangential inlet device for solids distribution trailer according to claim 1, wherein the channeller is of a straight shape, a curved shape, a spoon shape and the outlet is at a height between 1 and 30 mm from the center of the rotating plate or disc.

4. The tangential inlet device for solids distribution trailer according to claim 1, wherein the channeller generates an additional speed to the material to be distributed, and in the same direction of the pallets.

5. The tangential inlet device for solids distribution trailer according to claim 1, wherein the channeller rotates over its vertical axis, either in manual form through a slide, in automatic form through an electric engine or through a hybrid of both mechanisms.

6. The tangential inlet device for solids distribution trailer according to claim 1, wherein the flat area in the center of the rotating plate or disc has a diameter of 20 to 150 mm.

7. The tangential inlet device for solids distribution trailer according to claim 1, wherein the rotating plate or disc has a flat shape or a concave shape.

8. The tangential inlet device for solids distribution trailer according to claim 1, wherein the access to the material to be distributed to the spreader pallets is tangential thereof.

9. The tangential inlet device for solids distribution trailer according to claim 1, wherein adjusting the dimensions of the different components forms a kit to replace the devices for distribution of granular materials used in different trademarks and models of machines of agricultural use or similar uses.
